(19) United States
(12) Patent Application Publication
(10) Pub. No.: US 2021/0040913 A1
(43) Pub. Date: Feb. 11, 2021

(54) METHOD FOR OPERATING A SPARK-IGNITION INTERNAL COMBUSTION ENGINE

(71) Applicant: AVL LIST GMBH, Graz (AT)

(72) Inventor: Paul Kapus, Judendorf (AT)

(21) Appl. No.: 16/963,967

(22) PCT Filed: Jan. 23, 2019
(86) PCT No.: PCT/AT2019/060024

§ 371 Date: Jul. 22, 2020

(30) Foreign Application Priority Data
Jan. 23, 2018 (AT) A 50057/2018

(51) Int. Cl. F02D 41/40; F02B 23/10

(52) U.S. Cl. CPC F02D 41/402; F02B 2023/102; F02B 2023/103; F02B 23/10

(57) ABSTRACT

Various embodiments of the present disclosure are directed to methods of operating a spark-ignition internal combustion engine. In one embodiment, a method is disclosed including fuel is injected centrally into a combustion chamber via at least one fuel injection device per cylinder in at least one operating range of the internal combustion engine and is ignited centrally in the combustion chamber via at least one ignition device. The fuel is injected into the combustion chamber at an injection pressure of over 500 bar in the second half of the compression stroke before the top dead center of combustion and the internal combustion engine is operated at an air-fuel ratio λ≥1.

In at least one operating range of the internal combustion engine, the fuel is injected into the combustion chamber between 180° and 0° before the top dead center.

The invention relates to a method for operating a spark-ignition internal combustion engine which has at least one piston which reciprocates in a cylinder and adjoins a combustion chamber, wherein fuel is injected approximately centrally into the combustion chamber via at least one fuel injection device per cylinder in at least one operating range of the internal combustion engine and is ignited approximately centrally in the combustion chamber via at least one ignition device, wherein the fuel is injected into the combustion chamber at an injection pressure of more than 500 bar in the second half of the compression stroke before the top dead center of combustion and the internal combustion engine is operated at an air-fuel ratio λ=1 or λ>1. Furthermore, the invention relates to a gasoline internal combustion engine for carrying out the method.

From EP 2 239 446 A1, it is known that a gasoline internal combustion engine can be operated according to a HCCI process (HCCI=Homogenous Charge Compression Ignition) with spark-assisted homogeneous compression ignition of the fuel or conventionally with spark ignition, depending on the load requirement, in order to increase efficiency and reduce emissions. In order to reduce combustion noise, it is proposed to inject the fuel several times at a high injection pressure above 50 MPa via a multi-nozzle fuel injection device, with the last injection taking place at a late point in the compression cycle. The internal combustion engine is operated with a fuel/air ratio λ of at least 2.

DE 10 2012 002 315 A1 describes a spark-ignition internal combustion engine and a method of controlling it, wherein, depending on the engine load range, the control system sets the combustion mode to a mode with ignition by compression or a spark-ignition mode. The internal combustion engine is operated with a fuel/air ratio λ of 1. This also controls the fuel pressure and the time of fuel injection and ignition. From this publication it is known that by injecting the fuel at a comparatively high fuel pressure of about 40 MPa and above, at a time close to the top compression dead center, the combustion time can be shortened and thus the combustion stability can be improved.

Furthermore, it is known from WO 08/157823 A1 that main injection is carried out at fuel pressures of 1000 bar and above with an injection start in the crank angle range between −10° and 20° of top dead center in HCCI or PCCI operation (PCCI=Premixed Charge Compression Ignition). Furthermore, it is known from this publication that a fuel injection system is also to be used in which diametrically opposed injection jets for late fuel injection have a jet angle of between 120° and 150°. The compression ratio is between 10 and 16, the swirl ratio is between 0 and 1.5.

Internal combustion engines with components thermally insulated, for example by a ceramic layer, are known from U.S. Pat. No. 2,017,145 914 A.

From DE 10 2017 113 523 A1 an internal combustion engine is known whose combustion chamber has a thermally insulating element which forms at least part of the inner surface of the combustion chamber. The inner surface of the combustion chamber formed by the thermally insulating element can be wetted with water by means of an injection device.

Conventional spark-ignition internal combustion engines usually have measures to limit knocking. Fuel properties as well as time boundary conditions for mixture preparation and flame front propagation limit the compression ratio in spark-ignition internal combustion engines. Due to the high pressure and high temperature in the combustion chamber, self-ignition of part of the mixture can occur with a sharp increase in pressure (knocking). Such uncontrolled self-ignition can cause severe damage to the internal combustion engine. Furthermore, so-called irregular combustion (ignition of the mixture before ignition by the ignition device) can lead to damage to the internal combustion engine.

It is known that the efficiency of an internal combustion engine can be increased by thermal insulation. By at least approximately adiabatic engines, efficiencies of over 50% could theoretically be achieved. The disadvantage is that such engines are extremely susceptible to irregular combustion and knocking phenomena.

It is the object of the invention to avoid these disadvantages and to increase the efficiency without increasing the risk of irregular combustion and knocking phenomena.

According to the invention, this is achieved by injecting the fuel into the combustion chamber between 180°, preferably 120°, particularly preferably 90° and 0° crank angle before the top dead center of combustion in at least one operating range of the internal combustion engine in such a way that at least two injection jets of the fuel are directed at bowl walls of a preferably approximately circular piston bowl of the piston, which bowl walls are disposed substantially parallel to the cylinder axis and approximately diametrically opposite with respect to the cylinder axis, wherein the jet central axes of the two injection jets—when viewed in a sectional view containing the cylinder axis—enclose an angle of more than 30°, preferably more than 60°, in particular more than 80°, particularly preferably more than 100°, and in that the combustion heat is retained in the combustion chamber by at least one thermal insulation and/or coating.

The fuel is injected very late and immediately before the mixture is ignited. In this case, the entire injection takes place before the ignition point. The mixture formation is predominantly completed at the time of ignition. Predominantly complete means that more than 90%, preferably at least 95% of the fuel is mixed with air. At the time of ignition there is an approximately homogeneous mixture, in particular a quasi-homogeneous mixture in the cylinder. “Quasi-homogeneous” in this context means that in a central region of the combustion chamber above the piston bowl a zone with a homogeneous mixture is formed, and radially outside this central region an annular region with a zone with air or a lean base mixture. Combustion is carried out as a premixed combustion, i.e. there is no layer combustion or diffusion combustion. This has the advantage that due to the after-reaction between oxygen—O₂ and carbon black—C to CO₂ the premixed combustion is very low in carbon black. The exhaust gas also has a quasi-homogeneous composition with a CO<1% content, especially between 0.6-0.8%, and an O₂<1% content.

Due to the late injection timing and the high injection pressure, the mixture formation and combustion time is greatly reduced. Together with the stoichiometric mixture ratio and the impact of the fuel jets on the bowl walls running essentially parallel to the cylinder axis, knocking phenomena as well as irregular self-ignition or glow ignition are reliably prevented. This makes it possible to insulate the combustion chamber without increasing the risk of knocking, irregular self-ignition or glow ignition. Due to the thermally insulated combustion chamber, adiabatic state changes can be approximated, which allows a significant increase in thermal efficiency.

Preferably, the fuel is injected at an injection pressure above 900 bar, preferably above 1000 bar. The fuel injected at a high injection pressure and in particular in a supercritical manner causes high turbulence in the combustion chamber and thus enables very rapid mixture formation. The supercritical inflow of fuel is in a thermodynamic state in which the densities of the liquid phase and the gas phase are matched.

In one embodiment variant of the invention it is provided that the fuel is injected into the combustion chamber via at least six injection jets simultaneously. This enables an even distribution of the fuel in the combustion chamber.

In order to enable the mixture to ignite rapidly, it is advantageous to inject fuel via one injection jet on each side of the ignition point of the ignition device, with preferably at least two injection jets—viewed in plan view—enclosing an angle of approximately between 50° and 80°.

In order to enable rapid ignition of the mixture and in particular to avoid extinguishing the ignition spark, it is advantageous for at least one injection jet to have a defined distance from the ignition point, which is between 0.5 mm and 2.5 mm.

In a simple embodiment, it is provided that fuel injection will be carried out by means of a single injection per working cycle and cylinder immediately before the top dead center of combustion. However, for uniform mixture preparation, it is preferable for the fuel to be injected at at least two points in time, with at least one last injection taking place immediately before the top dead center of combustion.

In one embodiment variant of the invention, it is provided that at least two injections—preferably as a double—are carried out in the compression stroke. A further embodiment of the invention provides that at least two injections are carried out in the intake stroke and at least one injection in the compression stroke.

With each injection, the fuel is preferably injected over a maximum of 50°, preferably 30°, especially preferably 20°, crank angle.

A further increase in thermal efficiency can be achieved if the internal combustion engine is operated according to the Miller or Atkinson cycle process—with early or late intake closure.

Within the scope of the invention, it is provided that the internal combustion engine is operated with a tumble number of maximum 1. The geometric compression ratio is preferably between 12 and 18.

In a further embodiment of the invention it may be provided that at least at one point in time during at least one working cycle water is added to the intake air or fuel or fed into the combustion chamber. The water may be injected into the intake manifold or the intake ducts or directly into the combustion chamber or be supplied as an emulsion together with the fuel.

A spark-ignition internal combustion engine with at least one piston reciprocating in a cylinder and adjoining a combustion chamber is suitable for carrying out the method according to the invention, having at least one fuel injection device and at least one ignition device per cylinder, wherein the fuel injection device and/or the ignition device opens centrally into the combustion chamber, and wherein the fuel injection device is designed to inject fuel into the combustion chamber at an injection pressure above 500 bar, in the second half of a compression stroke before the top dead center of combustion, and to operate the internal combustion engine with an air number λ=1 or λ>1. In accordance with the invention, the fuel injection device has at least two injection ports whose central axes—when viewed in a side view of the fuel injection device—enclose an angle of more than 30°, preferably more than 60°, in particular more than 80°, particularly preferably more than 100°, wherein the fuel injection device is arranged and the piston is designed in such a way that, when fuel is injected in a crank angle range between 180°, preferably 120°, particularly preferably 90° and 0° crank angle before the top dead center of the combustion, the injection jets of the two injection ports meet bowl walls of a preferably circular piston bowl of the piston, which bowl walls are formed substantially parallel to the cylinder axis and are diametrically opposite with respect to the cylinder axis, wherein at least one wall adjoining the combustion chamber has thermal insulation.

The thermal insulation is expediently arranged in the area of the piston surface on the combustion chamber side—or parts of the piston surface—and/or in the area of a—preferably roof-shaped—combustion chamber top surface formed by a cylinder head—or parts of the combustion chamber top surface. Furthermore, the thermal insulation—on the piston side and/or cylinder side—can be arranged in the area of the top land of the piston. In this way heat losses can be reduced.

The piston preferably has a central elevation in the middle of the piston bowl, which may be circular, with the elevation extending into the combustion chamber. Similar pistons are known from diesel combustion engines.

The fuel injection system has several—for example six—injection ports. At least two injection ports of the fuel injection devices are advantageously arranged in such a way that fuel can be injected via one injection jet on each side of the ignition point of the ignition device. In one embodiment of the invention it is provided that the central axes of the injection ports of the two injection jets—when seen in plan view—enclose an angle of approximately between 50° and 80°. In order to ensure reliable ignition of the fuel-air mixture on the one hand and to avoid wetting of the ignition location with fuel on the other hand, it is advantageous if the fuel injection device and the ignition device are arranged in such a way that at least one injection jet has a defined distance from the ignition location of the ignition device which is between 0 mm and 2.5 mm.

The fuel injection device can be controlled via an electronic control unit in such a way that the fuel can be injected at at least two points in time during a working cycle, wherein at least one last injection takes place immediately before the top dead center of combustion. At least two injections can be carried out immediately one after the other in the compression stroke.

It is also possible to condition the control unit so that at least two injections can be carried out in the intake stroke and at least one injection in the compression stroke.

By splitting the fuel injection into several partial injections, the fuel-air mixture is cooled by the extracted evaporation energy, thus reducing the tendency for irregular combustion and knocking. The cooling of the fuel-air mixture can be further increased if water can be added to the intake air or fuel or fed to the combustion chamber via a water supply device. In this case, a water injection device can, for example, lead into the intake manifold, into the individual intake ducts or into the combustion chamber. Alternatively, water can be added to the fuel before it is injected into the combustion chamber and a fuel-water emulsion formed. This fuel-water emulsion can be injected into the combustion chamber via the fuel injection device.

Multiple fuel injections create turbulence within the combustion chamber, which has a positive effect on the flame propagation speed and thus further reduces the tendency to knock. Several short injections have proven to be more advantageous than a few long injections. The control of the injection can be advantageously conditioned in such a way that the fuel can be injected over a maximum of 50°, preferably 30°, especially preferably 20°, crank angle KW for each injection. The combustion chamber and the intake ducts should be designed in such a way that the tumble number (swirl number for tumble flow) in the combustion chamber is at most 1.

In order to further increase efficiency by reducing throttle losses, it may be provided that the internal combustion engine can be operated with early or late intake closure according to the Miller or Atkinson cycle. Early closing of the intake valves can be made possible, for example, by a variable valve train.

In connection with the method according to the invention, it is particularly advantageous if at least one ignition device is designed as a prechamber spark plug. This enables a further increase in combustion speed and efficiency while reducing the tendency to knock.

The invention is explained in more detail below on the basis of the embodiment example shown in the non-limiting figures. The drawings show schematically:

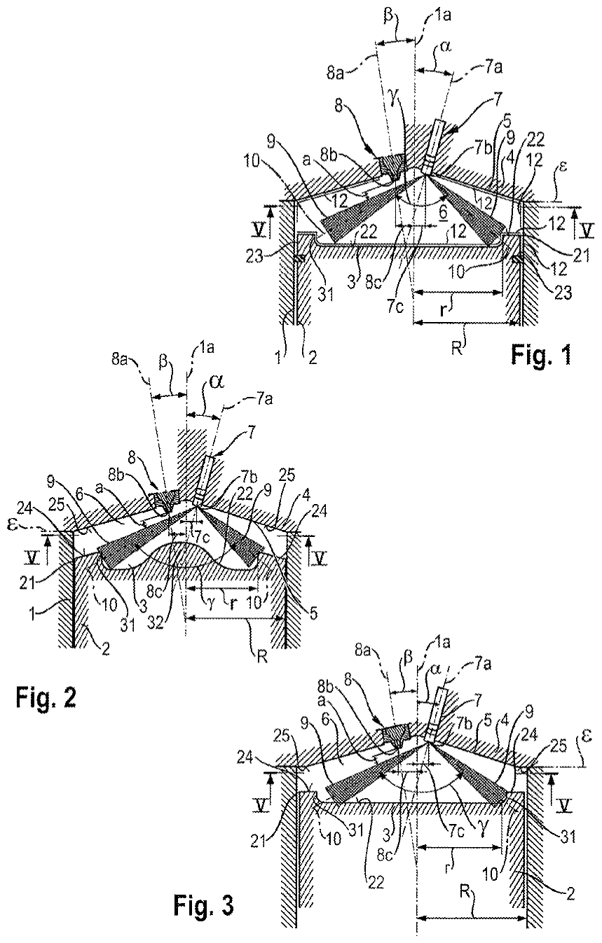

FIG. 1 shows a cylinder of an internal combustion engine for carrying out the method according to the invention in a first embodiment variant in a longitudinal section;

FIG. 2 shows a cylinder of an internal combustion engine for carrying out the method according to the invention in a second embodiment variant in a longitudinal section;

FIG. 3 shows a cylinder of an internal combustion engine for carrying out the method according to the invention in a third embodiment variant in a longitudinal section;

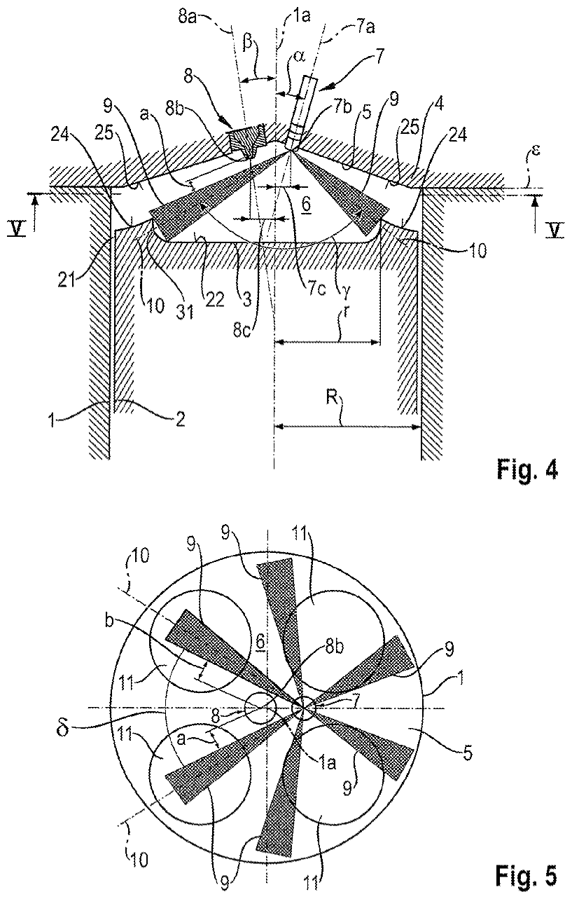

FIG. 4 shows a cylinder of an internal combustion engine for carrying out the method according to the invention in a fourth embodiment variant in a longitudinal section;

FIG. 5 shows the cylinder in a section according to line IV-IV in FIG. 1, 2, 3 or 4,

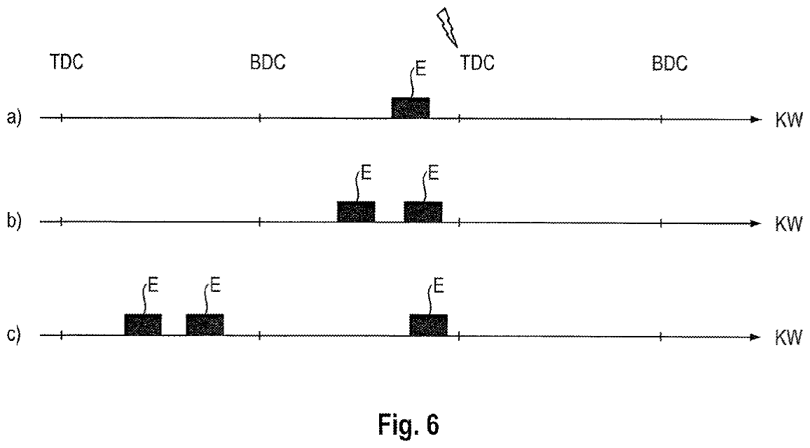

FIG. 6 shows injection events when carrying out the method according to the invention in different variants of the invention;

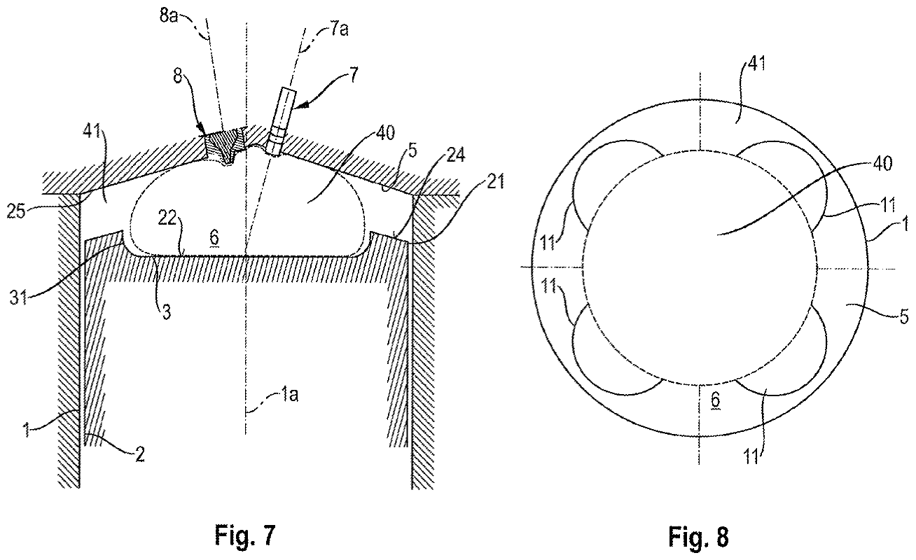

FIG. 7 shows the cylinder from FIG. 4 in a longitudinal section with indicated core zone; and

FIG. 8 shows this cylinder in a section according to line VIII-VIII in FIG. 7.

FIG. 1 to FIG. 4 schematically show in each case a cylinder 1 of a spark-ignition internal combustion engine, in which a reciprocating piston 2 is displaceably arranged. Piston 2, which has a piston bowl 3, acts on a crankshaft via a connecting rod not shown further. A combustion chamber 6 is formed between piston 2 and the roof-shaped combustion chamber ceiling 5 formed by a cylinder head 4. A fuel injection device 7 and an ignition device 8—for example a conventional spark plug with electrodes which open directly into the combustion chamber 6—open centrally into the combustion chamber 6. The ignition device 8 can also be designed as a prechamber spark plug—shown in the illustration—with an integrated prechamber in which the electrodes are arranged, wherein the prechamber is connected to the combustion chamber 6 via several openings. It is also possible to provide more than one fuel injection device 7 and/or more than one ignition device 8 per cylinder 1.

The axis 7a of the fuel injection device 7 may be inclined to the cylinder axis 1a. Similarly, axis 8a of the ignition device 8 may be inclined to cylinder axis 1a. In the example shown, the angle of inclination α between axis 7a and cylinder axis 1a, for example, is approximately 15°, and the angle of inclination β between axis 8a and cylinder axis 1a, for example, is approximately 10°. The inclination angles α, β can preferably be between 0° and 30°, and particularly preferably between 0° and 15°.

The injection location 7b of the fuel injection device 7 and the ignition location 8b of the ignition device 8 are located near the cylinder axis 1a. The distance 7c between the injection location 7b and cylinder axis 1a is less than a quarter of the radius R of cylinder 1. The same applies to the distance 8c between the ignition location 8b and cylinder axis 1a.

The fuel injection device 7 is designed as a multi-hole injection device to inject the fuel into the combustion chamber 6 in several injection jets 9 via several (not shown) injection ports. The central axes 10 of two injection ports of the fuel injection device 7 for approximately diametrically opposed injection jets 9—when viewed in a side view of the fuel injection device as shown in FIG. 1 and FIG. 2—form an angle γ of over 30°, preferably over 60°, in particular over 80°, particularly preferably over 100°. This angle γ corresponds to the jet angle formed by the jet axes of the two approximately diametrically opposed injection jets 9. In the embodiment example shown, the angle γ is about 110°.

The radius r of the substantially circular piston bowl is between 0.7 and 0.9 times the piston radius R. In the region furthest from the cylinder axis 1a, the piston bowl has 3 bowl walls 31 facing away from the piston edge 21, which are formed substantially parallel to the cylinder axis 1a.

The fuel injection (for single injection) or the last fuel injection (for multiple injection) takes place very late in the compression stroke near the top dead center TDC of the combustion, wherein the central axes 10 of the injection ports or the jet axes of the injection jets 9 are directed towards the bowl walls 31. The injection jets 10 thus travel the longest possible distance within combustion chamber 6 before they hit piston 2. The fuel can thus vaporize in the best possible way.

As can be seen from FIG. 5, the fuel injection device 7 has a star-shaped jet pattern of the injection jets 9, wherein six injection ports are provided in the embodiment example shown. Reference numeral 11 designates gas exchange valves arranged in the combustion chamber ceiling 5. At least two injection ports of the fuel injection device 7 are arranged so that fuel is injected via one injection jet 9 on each side of the ignition point 8b of the ignition device 8. The central axes 10 of these injection ports enclose an angle δ which is approximately between 50° and 80°.

The injection jets 9 have a distance a from the ignition point 8b, which is between 0 mm and 2.5 mm. This ensures reliable ignition of the fuel-air mixture.

As can be seen from FIG. 1, walls or wall areas adjacent to the combustion chamber 6 have thermal insulations 12. In particular, thermal insulations 12 are provided in the area of the piston surface 22—i.e. in the area of the piston bowl 3 and in the area between piston bowl 3 and piston rim 21—, in the area of the combustion chamber ceiling 5, and in the area of cylinder 1 bordering on combustion chamber 6, but also in the area of the top land 23 of piston 2 and in an area of cylinder 1 opposite the top land 23. In FIG. 2 the insulations 12 are not shown.

The embodiment variant shown in FIG. 2 differs from FIG. 1 in that the piston bowl 3 has a central elevation 32. Furthermore, the areas of the piston surface 22 between the piston bowl 3 and the piston rim 21 facing the combustion chamber 6 are designed as squeezing surfaces 24, whose inclination and shape essentially corresponds to the roof inclination of the roof-shaped combustion chamber ceiling 5. The corresponding squeezing surfaces on the cylinder head side of the combustion chamber ceiling 5 are designated by reference numeral 25.

Squeezing surfaces 24 on the piston side between the piston bowl 3 and the piston rim 21 on the one hand and squeezing surfaces 25 on the cylinder head side of the combustion chamber ceiling 5 on the other hand are also provided in the third embodiment variant of the invention shown in FIG. 3. The squeezing surfaces 24, 25 are designed to be flat and parallel to the cylinder head sealing plane E. Within the cylinder-head-side squeezing surfaces 25, the combustion chamber ceiling 5 is roof-shaped.

FIG. 4 shows a further embodiment variant of the invention with areas of the piston surface 22 formed between the piston bowl 3 and the piston rim 21 as squeezing surfaces 24, wherein the squeezing surfaces 24 at least partially follow the shape of the roof-shaped combustion chamber ceiling 5. The squeezing surfaces 24 and the corresponding cylinder-head-side squeezing surfaces 25 of the combustion chamber ceiling 5 are slightly curved in FIG. 4, wherein the gradient of the piston surface 22 or the combustion chamber ceiling 5 are smaller in the region of the piston edge 21 or cylinder edge than in a region closer to the cylinder axis 1a. It is understood that thermal insulation can also be provided for the embodiments shown in FIG. 2 to FIG. 4.

According to the method according to the invention, the internal combustion engine is operated at least approximately adiabatically and with a stoichiometric air-fuel ratio λ=1 and the fuel is injected very late in the compression stroke near the top dead center TDC of the combustion with very high injection pressure of more than 500 bar, in particular more than 900 bar, for example 1000 bar.

Alternatively, the internal combustion engine can be operated at least approximately adiabatically and with a lean air-fuel ratio λ>1 and the fuel in the compression stroke can be injected very late near the top dead center TDC of the combustion with very high injection pressure of over 500 bar, especially over 900 bar, for example 1000 bar.

In any case, the fuel is injected very late and immediately before the mixture is ignited. In this case, the entire injection takes place before the ignition point. At the time of ignition, the mixture formation is predominantly complete, with more than 90%, preferably at least 95% of the fuel being mixed with air. At the time of ignition there is an approximately homogeneous mixture, in particular a quasi-homogeneous mixture in the cylinder. A zone with a homogeneous mixture is formed in a central region 40 of the combustion chamber 6 substantially above the piston bowl 3, and radially outside this central region 40 a substantially annular region 41 with a zone with air or a lean base mixture is formed, as shown in FIG. 7 and FIG. 8. This has the advantage that due to the after-reaction between oxygen—O₂ and carbon black—C to CO₂, the premixed combustion takes place with very little carbon black. The exhaust gas also has a quasi-homogeneous composition with a content of CO<1%, especially between 0.6-0.8%, and a content of O₂<1%.

The internal combustion engine can be operated according to the Miller or Atkinson cycle with an early or late intake closure. The intake ducts of the internal combustion engine and combustion chamber 6 are designed to achieve a low tumble number, in particular a tumble number ≤1.

The internal combustion engine may be of the two-stroke or four-stroke type.

The fuel injection E can be carried out once or several times as shown schematically in FIG. 6a to FIG. 6c. In FIG. 6a to FIG. 6c the injection events E are plotted over the crank angle for one work cycle at a time, wherein the top dead centers are marked TDC and the bottom dead centers BDC.

FIG. 6a shows a variant of the method according to the invention with a single fuel injection E during the compression stroke.

FIG. 6b shows a variant of the method according to the invention with two fuel injections E during the compression stroke.

FIG. 6c shows a variant of the method according to the invention with three fuel injections E, wherein the first two fuel injections E take place during the intake stroke and one fuel injection E during the compression stroke.

In addition, one or more injections can be provided in the intake stroke. The individual injections in the compression stroke and in the intake stroke can have different quantity distributions in a ratio between 10/90 and 90/10. Even with more than two injection events, the fuel quantities can be divided up differently. For example, the quantity distribution for three injection events can be 10/25/65 or 60/30/10.

1. Method for operating a spark-ignition internal combustion engine which has at least one piston which reciprocates in a cylinder and adjoins a combustion chamber, the method including the following steps:
injecting fuel centrally into the combustion chamber via at least one fuel injection device per cylinder in at least one operating range of the internal combustion engine;
centrally igniting the combustion chamber via at least one ignition device;
wherein the fuel is injected into the combustion chamber at an injection pressure of more than 500 bar in a second half of a compression stroke before top dead center of combustion, and the internal combustion engine is operated at an air-fuel ratio λ≥1, characterized in that;
wherein in at least one operating range of the internal combustion engine, the fuel is injected between 180°, and 0° crank angle before the top dead center of the combustion into the combustion chamber in such a way that at least two injection jets of the fuel are directed at bowl walls of a piston bowl of the piston, which bowl walls are disposed substantially parallel to the cylinder axis and lie approximately diametrically opposite one another with respect to the cylinder axis; and
wherein a jet axes of the at least two injection jets—when viewed in a sectional view containing the cylinder axis—enclose an angle of more than 30°; and
retaining combustion heat in the combustion chamber by at least one thermal insulation and/or coating.

2. The method according to claim 1, wherein the fuel is injected at an injection pressure above 900 bar, in such a way that a homogeneous mixture is formed in a region above the piston bowl.

3. The method according to claim 1, wherein the fuel is injected simultaneously into the combustion chamber via at least five injection jets.

4. The method according to claim 1, wherein fuel is injected on both sides of the ignition point of the ignition device via one injection jet each.

5. The method according to claim 4, wherein the at least two injection jets—when viewed in plan view—enclose an angle of approximately between 50° and 80°.

6. The method according to of claim 1, wherein at least one injection jet has a defined distance from the ignition point which is between 0.5 and 2.5 mm.

7. The method according to of claim 1, wherein the fuel is injected at at least two points in time, wherein at least one last injection takes place immediately before the top dead center of combustion.

8. The method according to claim 1, wherein at least two injections are carried out in the compression stroke.

9. The method according to claim 1, wherein at least two injections are carried out in the intake stroke and at least one injection in the compression stroke.

10. The method according to claim 1, wherein during each injection the fuel is injected over a maximum of 50° KW.

11. The method according to claim 1, wherein the entire injection of the fuel is terminated at or before the time of ignition.

12. The method according to claim 1, wherein until the time of ignition a homogeneous mixture is formed in a central region above the piston bowl and radially outside the central region a peripheral zone is formed with air or lean base mixture, so that after the time of ignition a premixed combustion is carried out.

13. The method according to claim 1, wherein the internal combustion engine is operated with a compression ratio between 12 and 18.

14. The method according to claim 1, wherein the internal combustion engine is operated with an air-fuel ratio λ=1.

15-28. (canceled)

29. The method according to claim 1, wherein the jet axes of the at least two injection jets—when viewed in a sectional view containing the cylinder axis—enclose an angle of more than 60°.

30. The method according to claim 1, wherein the jet axes of the at least two injection jets—when viewed in a sectional view containing the cylinder axis—enclose an angle of more than 100°.

31. The method according to claim 2, wherein the fuel is injected supercritically.

32. The method according to claim 1, wherein during each injection the fuel is injected over a maximum of 20° crank angle.
